(19) United States
(12) Patent Application Publication
(10) Pub. No.: US 2026/0320736 A1
(43) Pub. Date: Oct. 15, 2026

(54) MEDIA CONTENT GENERATION

(71) Applicant: Beijing Zitiao Network Technology Co., Ltd., Beijing (CN)

(72) Inventors: Jie Wu, Beijing (CN); Liang Li, Beijing (CN); Weilin Huang, Beijing (CN)

(21) Appl. No.: 19/647,180

(22) Filed: Apr. 14, 2026

(30) Foreign Application Priority Data
Apr. 14, 2025 (CN) 202510467568.2

(51) Int. Cl. G06T 3/40; G06T 5/60; G06T 5/70; G06T 7/11; G06T 7/73

(52) U.S. Cl. CPC G06T 3/40; G06T 5/60; G06T 5/70; G06T 7/11; G06T 7/73; G06T 2207/20081; G06T 2207/30168

(57) ABSTRACT

According to embodiments of the disclosure, a method, an apparatus, a device, and a storage medium for generating media content are provided. The method includes: obtaining input information; and providing the input information to a model to generate the media content, a training phase of the model including a first training phase and a second training phase, the first training phase being configured to train the model by using a first set of training media content corresponding to a first resolution; and the second training phase being configured to sample a second resolution from a set of candidate resolutions; and train the model by using a second set of training media content corresponding to the second resolution, a resolution range corresponding to the set of candidate resolutions being higher than the first resolution.

### CROSS-REFERENCE

The present application claims priority to Chinese Patent Application No. 202510467568.2, filed on Apr. 14, 2025, and entitled "METHOD, APPARATUS, DEVICE, AND STORAGE MEDIUM FOR MEDIA CONTENT GENERATION", which is incorporated herein by reference in its entirety.

### FIELD

Example embodiments of the present disclosure generally relate to the field of computers, and in particular, to media content generation.

### BACKGROUND

With the development of computer technologies, generative models are models that automatically generate various types of media content based on input instructions, data, or some form of guidance. However, the media content directly generated by a foundation model is small in size, and the small resolution may cause the media content to be insufficient in detail depiction, clarity, etc., and the visual effect is not ideal, which is difficult to meet some application scenarios with high requirements for image quality.

### SUMMARY

In a first aspect of the present disclosure, a method for generating media content is provided. The method includes: obtaining input information; and providing the input information to a model to generate the media content, a training phase of the model including a first training phase and a second training phase, the first training phase being configured to train the model by using a first set of training media content corresponding to a first resolution; and the second training phase being configured to sample a second resolution from a set of candidate resolutions; and train the model by using a second set of training media content corresponding to the second resolution, a resolution range corresponding to the set of candidate resolutions being higher than the first resolution.

In a second aspect of the present disclosure, an apparatus for generating media content is provided. The apparatus includes: an obtaining module configured to obtain input information; and a generation module configured to provide the input information to a model to generate the media content, a training phase of the model including a first training phase and a second training phase, the first training phase being configured to train the model by using a first set of training media content corresponding to a first resolution; and the second training phase being configured to sample a second resolution from a set of candidate resolutions; and train the model by using a second set of training media content corresponding to the second resolution, a resolution range corresponding to the set of candidate resolutions being higher than the first resolution.

In a third aspect of the present disclosure, an electronic device is provided. The device includes at least one processor; and at least one memory, the at least one memory being coupled to the at least one processor and storing instructions for execution by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon, the computer program being executable by a processor to implement the method of the first aspect.

In a fifth aspect of the present disclosure, a computer program product is provided. The computer program product includes computer-executable instructions, the computer-executable instructions, when executed by a processor, implement the method according to the first aspect of the present disclosure.

It would be appreciated that content described in this Summary section is neither intended to limit key or essential features of embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a first flowchart of a process of generating media content according to some embodiments of the present disclosure;

FIG. 3 illustrates a second flowchart of a process of generating media content according to some embodiments of the present disclosure;

FIG. 4 illustrates a schematic structural block diagram of an apparatus for generating media content according to certain embodiments of the present disclosure; and

FIG. 5 illustrates a block diagram of an electronic device capable of implementing multiple embodiments of the present disclosure.

### DETAILED DESCRIPTION

Embodiments of the present disclosure will be described in more detail below with reference to the drawings. Although some embodiments of the present disclosure are shown in the drawings, it would be appreciated that the present disclosure may be implemented in various forms and should not be construed as limited to the embodiments set forth herein. Instead, these embodiments are provided for a more thorough and complete understanding of the present disclosure. It would be appreciated that the drawings and embodiments of the present disclosure are only for illustrative purposes, and are not intended to limit the protection scope of the present disclosure.

It should be noted that the titles of any section/subsection provided herein are not restrictive. Various embodiments are described throughout this article, and any type of embodiment may be included under any section/subsection. Furthermore, the embodiments described in any section/subsection may be combined with any other embodiments described in the same section/subsection and/or different section/subsection in any way.

In the description of the embodiments of the present disclosure, the term "include/comprise" and similar terms thereto should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". Other definitions, either explicit or implicit, may also be included below. The terms "first", "second", etc. may refer to different or same objects. Other definitions, either explicit or implicit, may also be included below.

The embodiments of the present disclosure may involve user's data, acquisition and/or use of data, etc. These aspects all comply with corresponding laws, regulations and related provisions. In the embodiments of the present disclosure, the collection, acquisition, processing, machining, forwarding, use, etc. of all data are carried out on the premise that the user is aware of and confirms. Accordingly, when implementing the embodiments of the present disclosure, the user should be informed of the data or the type of data, the scope of use, the use scenarios, etc. that may be involved, and the authorization of the user should be obtained in an appropriate manner in accordance with relevant laws and regulations. The specific manner of informing and/or authorizing may vary according to the actual situation and application scenarios, and the scope of the present disclosure is not limited in this regard.

If the solutions in this specification and embodiments involve personal-generated media content, the solutions will be processed on the premise that they have a legal basis (for example, the consent of the personal data subject is obtained, or it is necessary to perform a contract, etc.), and will only be processed within the scope of provisions or agreements. If the user refuses to process personal data other than the necessary data required for the basic functions, it will not affect the user's use of the basic functions.

Generative models are models that automatically generate various types of media content based on input instructions, data, or some form of guidance. However, the media content directly generated by a foundation model is small in size, and the small resolution may cause the media content to be insufficient in detail depiction, clarity, etc., and the visual effect is not ideal, which is difficult to meet some application scenarios with high requirements for image quality. In order to improve the resolution, it is necessary to apply a super-resolution technology after the media content is generated to enlarge the low-resolution media content into high-resolution media content, thereby obtaining a clearer output. However, the introduction of the super-resolution technology may impose certain limitations on the model performance.

The embodiments of the present disclosure provide a solution for generating media content. According to this solution, input information is obtained; and the input information is provided to a model to generate the media content, a training phase of the model including a first training phase and a second training phase, the first training phase being configured to train the model by using a first set of training media content corresponding to a first resolution; and the second training phase being configured to sample a second resolution from a set of candidate resolutions; and train the model by using a second set of training media content corresponding to the second resolution, a resolution range corresponding to the set of candidate resolutions being higher than the first resolution.

According to the embodiments of the present disclosure, the model is trained by applying the first set of training media content and the second set of training media content with different resolutions, so that the model can better adapt to diverse input information, and the required media content can be directly output without applying the super-resolution technology, thereby improving the performance and generalization ability of the model.

### Example Environment

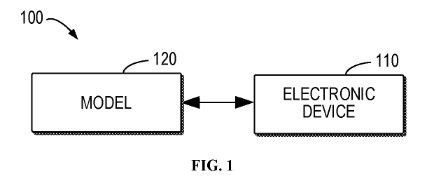

FIG. 1 illustrates a schematic diagram of an example environment 100 in which the embodiments of the present disclosure may be implemented. As shown in FIG. 1, the example environment 100 may include an electronic device 110. In some embodiments, the electronic device 110 may obtain input information; and provide the input information to a model 120 to generate media content, a training phase of the model 120 including a first training phase and a second training phase, the first training phase being configured to train the model by using a first set of training media content corresponding to a first resolution; and the second training phase being configured to sample a second resolution from a set of candidate resolutions; and train the model 120 by using a second set of training media content corresponding to the second resolution, a resolution range corresponding to the set of candidate resolutions being higher than the first resolution. The model 120 may be deployed on the electronic device 110 or on other devices, which will not be repeated here.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a TV receiver, a radio broadcast receiver, an e-book device, a game device, or any combination of the foregoing, including accessories and peripherals of these devices or any combination thereof. In some embodiments, the electronic device 110 may also support any type of interface for a target user (such as a "wearable" circuit, etc.).

The electronic device 110 may also be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The electronic device 110 may include, for example, a computing system/server, such as a mainframe, an edge computing node, a computing device in a cloud environment, and so on.

It would be appreciated that the structure and function of each embedded element in the environment 100 are described for illustrative purposes only, without suggesting any limitation to the scope of the present disclosure.

Some example embodiments of the present disclosure will be further described below with reference to the drawings.

### Example Process

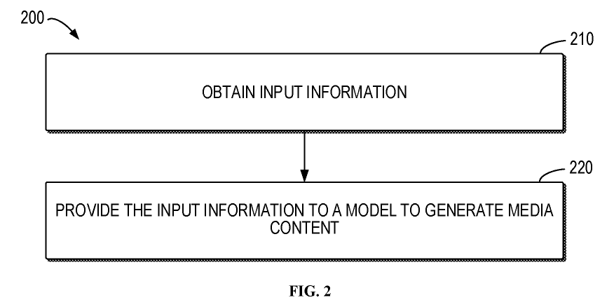

FIG. 2 illustrates a flowchart of a process 200 of generating media content according to some embodiments of the present disclosure. The process 200 may be implemented at the electronic device 110. The process 200 is described below with reference to FIG. 1.

At block 210, the electronic device 110 may obtain input information.

For example, the input information may be "a white dog", which indicates the model to generate media content about a white dog.

At block 220, the electronic device 110 may provide the input information to the model to generate the media content.

In some embodiments, the model is used to generate the corresponding media content based on the input information. The model in the embodiments of the present disclosure may be a multimodal generative diffusion model, which is a generative model based on a diffusion model and is capable of simultaneously processing and understanding data in multiple modals, such as text, image, audio, video, and so on. The core idea is to gradually transform random noise into data that conforms to the target modal distribution through iterative denoising of the diffusion process, while maintaining semantic alignment between multimodal data.

In some embodiments, in order to improve the generality of the model under an unknown resolution, the model may be trained by a mixed-resolution training method. The training phase of the model includes a first training phase and a second training phase. The first training phase is configured to train the model by using a first set of training media content corresponding to a first resolution. The second training phase is configured to sample a second resolution from a set of candidate resolutions and train the model by using a second set of training media content corresponding to the second resolution, wherein a resolution range corresponding to the set of candidate resolutions is higher than the first resolution. Through this mixed-resolution training, the diversity of data can be significantly increased, and the versatility of the model under the unknown resolution can be improved, so that the model can directly output a result without applying the super-resolution technology.

For example, the first resolution may be 256 × 256, and the resolution range corresponding to the set of candidate resolutions is 512 × 512 to 4096 × 4096. The second resolution, such as 1024 × 1024, may be randomly sampled from the set of candidate resolutions. Then, the first set of training media content corresponding to the first resolution is determined, and the second set of training media content corresponding to the second resolution is determined. The model is first trained by using the first set of training media content corresponding to the first resolution, and then trained by using the second set of training media content corresponding to the second resolution.

In the model training process, in order to enhance the adaptability of the model, images with different aspect ratios may also be combined for training in each training phase. This method may enable the model to better adapt to diverse input information, thereby improving the performance and generalization ability of the model. For example, samples in the first set of training media content include multiple aspect ratios, and an average resolution of the samples in the first set of training media content is the first resolution. Samples in the second set of training media content include multiple aspect ratios, and an average resolution of the samples in the second set of training media content is the second resolution.

In some embodiments, in order to enable the model to perceive a target resolution, size embedding may also be input as a condition to guide the model to generate media content that meets the target resolution. The electronic device 110 may determine a control feature based on a resolution of the training media content. Then, the control feature is input to the model to train the model using the training media content. For example, it is possible to determine the target resolution of the media content that the model needs to generate, then apply a scaling control parameter, input encoding information corresponding to the target resolution to the model, and train the model.

In some embodiments, the electronic device 110 may sample a first set of denoising time steps. Then, the first set of denoising time steps are adjusted based on the resolution of the training media content to determine a second set of denoising time steps. Then, the diffusion model is trained using the training media content based on the second set of denoising time steps. The denoising time steps are sampled from a distribution p(t;D) related to the resolution of the training media content. This distribution is generated based on a logit-normal distribution and then adjusted by an offset based on the resolution of the training media content.

Specifically, for a high-resolution image, since detail generation is more complicated, more attention needs to be paid to a denoising time step with a low signal-to-noise ratio. Therefore, if the average resolution of the training media content is high, the denoising time step distribution is shifted in the direction of the low signal-to-noise ratio, so that the model more frequently samples a later time step with larger noise, thereby learning how to better denoise under the high resolution. If the average resolution of the training media content is low, the time step is shifted in the direction of a high signal-to-noise ratio, since the generation task is relatively simple.

In some embodiments, the performance of model training may be improved by enriching the training media content set. The electronic device 110 may obtain candidate media content, and then detect whether the candidate media content includes a defect element. Then, in response to the candidate media content including the defect element, a size ratio of the defect element in the candidate media content is determined, and then in response to the size ratio being less than a threshold, the candidate media content is added to a training media content set.

In some embodiments, the defect element includes a watermark element. A defect refers to a part of the media content that is incomplete, distorted, or contains interference due to quality problems in the process of shooting, transmission, storage, or generation, such as a watermark, superimposed text, a subtitle, or a mosaic. In existing technologies, such defective media content is often directly deleted, but such images account for a relatively large proportion in the original sample set, and thus the size of the available sample set is greatly limited in such a manner.

In order to limit the size of the available sample set as little as possible, a defect-aware training method may be adopted, that is, a dedicated defect detection model is introduced, which actively identifies or adapts to defects in data during the training process. The defect detection model precisely locates the defect element through bounding box prediction and marks the defect element. For example, it is possible to obtain the candidate media content, then apply the defect detection model to detect whether the candidate media content includes the defect element, and mark a defect part of the candidate media content that includes the defect element. Then, the size ratio of the defect element in the candidate media content is determined. If the size ratio is less than the threshold, such as 20%, it indicates that the proportion of defects in the candidate media content is relatively small, and the candidate media content with a relatively small proportion of defects may be added to the training media content set for use in model training. If the size ratio is greater than the threshold, such as 20%, it indicates that the proportion of defects in the candidate media content is relatively large, and thus it cannot be used and will no longer be added to the training media content set. The threshold may be adjusted according to the actual situation and is not limited here.

In some embodiments, the electronic device 110 may determine a mask corresponding to the defect element in response to the candidate media content including the defect element, the mask indicating a region corresponding to the defect element. Then, a training loss corresponding to the candidate media content is determined based on the mask, so that the training loss is independent of the region corresponding to the defect element. For example, the mask corresponding to the defect element may be determined through the previous marking, and when calculating the training loss, the gradient of the defect element is masked, that is, the defect element does not participate in the loss calculation and back propagation. In this way, it is possible to focus on the gradient update of the normal region, so that the model focuses more on learning valid semantic information.

In some embodiments, since the visual feature unit is in a matrix form and the text feature unit is a one-dimensional sequence, in order to achieve better alignment between the image and the text, the text feature unit may be regarded as a matrix with only one row. The electronic device 110 may obtain training media content and corresponding training text content, and then determine position information of a set of text feature units corresponding to the training text content. Then, a set of visual feature units corresponding to the training media content is updated based on the position information, and then the model is trained based on the updated set of visual feature units.

In some embodiments, the electronic device 110 may determine, from the set of text feature units, a target text feature unit corresponding to a target visual feature unit in the set of visual feature units. Then, based on the position information, a position encoding unit corresponding to the target text feature unit is added after the target visual feature unit, the position encoding unit indicating a position of the target text feature unit in the set of text feature units.

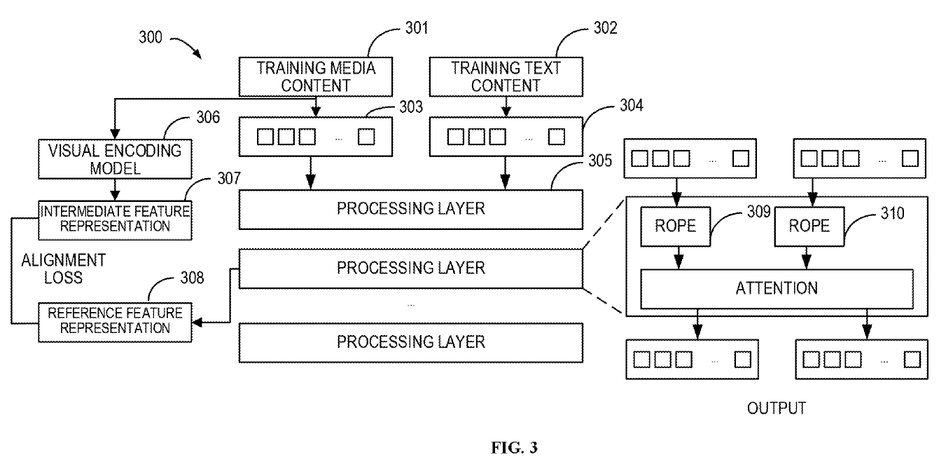

For example, referring to FIG. 3, the training media content 301 and the corresponding training text content 302 may be first obtained, and then the position information of the set of text feature units 304 corresponding to the training text content is determined. Then, a target text feature unit corresponding to a target visual feature unit in a set of visual feature units 303 is determined from the set of text feature units 304. Then, the target text feature unit is regarded as a matrix [1,L] with only one row, and rotary position encoding is applied to perform position embedding on the target visual feature unit and the target text feature unit, as shown in blocks 309 and 310 in FIG. 3. In the position embedding process, a position identification may be first allocated to the target visual feature unit, and then a column-wise position identification of the target text feature unit is continuously increased from the largest position identification of the target visual feature unit, thereby implementing the position embedding process in this way.

With this cross-modal rotary position encoding method, the intramodal relationship and the cross-modal relationship can be effectively simulated, cross-modal information can be captured, and the alignment of visual-text feature units can be further enhanced, thereby improving the overall performance of the model. Rotary position embedding (ROPE) is a position encoding method for a Transformer architecture. Absolute position information is injected into an attention mechanism through a rotation matrix to improve the long sequence modeling capability.

In some instances, in order to optimize the data distribution, the sample data may also be jointly optimized from two dimensions of visual form and semantic distribution. In the dimension of visual form, for example, hierarchical clustering may be applied to determine which category a sample in the training media content set belongs to, such as determining that the sample belongs to the tiger category under the animal category and the South China tiger category under the tiger category. Then, it is possible to determine which category of samples in the training media content set is insufficient according to a preset label system, and add samples of such category to the training media content set, so that the training media content set can cover all categories in the label system. If it is determined that there are insufficient samples of the Siberian tiger category under the tiger category and the tiger category under the animal category, images of the Siberian tiger are added to the training media content set. The label system is a structured classification framework for systematically labeling and organizing data. The data may be labeled according to specific rules and hierarchical relationships, so that it may be efficiently processed and analyzed by machines or humans.

In some embodiments, in the dimension of semantic distribution, for example, a sample with a low occurrence frequency may be determined by word frequency and inverse document frequency, and then such sample is added to the training text content set. Specifically, for some long-tailed texts, such as a style with a low occurrence frequency, they may be added to the training text content set to ensure the completeness of world knowledge.

In some embodiments, the training loss of the model may include alignment loss. The objective of the alignment loss is to ensure that the output of the model in different representation spaces is aligned with the target data distribution. This loss is commonly used to improve the quality of the generative model and make the generated samples closer to the real data.

In some embodiments, the electronic device 110 may obtain an intermediate feature representation output by an intermediate processing layer in the plurality of processing layers, and then encode the training media content using a trained visual encoding model to determine a reference feature representation. Then, the model is trained based on a difference between the intermediate feature representation and the reference feature representation. For example, referring to FIG. 3, for the alignment loss, it is possible to obtain the output intermediate feature representation 307 from the intermediate processing layer in the plurality of processing layers 305 of the model, encode 306 the training media content 301 using the trained visual encoding model to obtain the reference feature representation 308, then construct a loss based on the cosine distance between the intermediate feature representation 307 and the reference feature representation 308, and train the model using this loss. Introducing the alignment objective can accelerate the convergence of large-scale text-to-generated media content.

Human preferences and feedback may also be incorporated into the reinforcement learning process through reinforcement learning from human feedback (RLHF). In addition, the prompt input to the model may also be designed and optimized through prompt engineering (PE), thereby guiding the model to generate more compliant, accurate, and useful output. Through these methods, these prompts can provide accurate descriptions for the model in professional fields such as aesthetics, style, and layout, thereby ensuring that the model can respond to the relevant prompts more effectively.

In some embodiments, in order to improve the aesthetics of the media content generated by the model, aesthetic description may also be applied as input content for model training, so that the model may generate media content with beauty. The aesthetic caption not only describes what the objects in the picture are, but also focuses on describing aesthetics-related elements. For a picture of a seaside sunset, the aesthetic caption may be "the huge orange-red sun is gracefully hanging on the sea level, dyeing the sea a gorgeous golden red. The twinkling waves on the sea are like broken diamonds. The whole picture is rich and harmonious in color, full of quiet and magnificent beauty".

According to the embodiments of the present disclosure, the data scale of samples is greatly expanded by reserving samples with partial defects, and the samples are further enriched by jointly optimizing the sample data from the two dimensions of visual form and semantic distribution. In addition, the model can adapt to various resolutions by the mixed-resolution training method without applying the super-resolution technology. Through the rotary position encoding and the alignment loss, significant improvements can be presented in visual-text alignment and the text rendering performance can be enhanced.

### Example Apparatus and Device

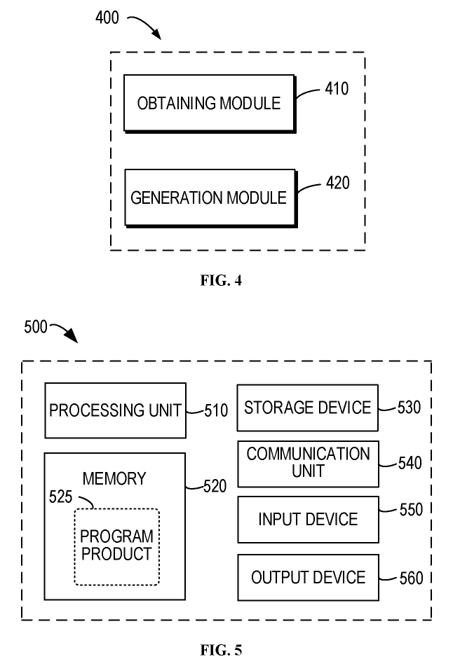

The embodiments of the present disclosure also provide corresponding apparatuses for implementing the above methods or processes. FIG. 4 shows a schematic structural block diagram of an apparatus 400 for generating media content according to some embodiments of the present disclosure. The apparatus 400 may be implemented as or included in the electronic device 110 as discussed above. Each module/component in the apparatus 400 may be implemented by hardware, software, firmware, or any combination thereof.

As shown in FIG. 4, the apparatus 400 includes an obtaining module 410 configured to obtain input information; and a generation module 420 configured to provide the input information to a model to generate the media content, where a training phase of the model including a first training phase and a second training phase, the first training phase being configured to train the model by using a first set of training media content corresponding to a first resolution; and the second training phase being configured to sample a second resolution from a set of candidate resolutions; and train the model by using a second set of training media content corresponding to the second resolution, where a resolution range corresponding to the set of candidate resolutions being higher than the first resolution.

In some embodiments, the training phase of the model includes: determining a control feature based on a resolution of the training media content; and inputting the control feature to the model to train the model by using the training media content.

In some embodiments, the training phase of the diffusion model includes: adjusting the first set of denoising time steps based on a resolution of training media content to determine a second set of denoising time steps; and training the diffusion model by using the training media content based on the second set of denoising time steps.

In some embodiments, the model is trained by using a training media content set, and the training media content set is determined based on the following process: obtaining candidate media content; detecting whether the candidate media content includes a defect element; determining, in response to the candidate media content comprising the defect element, a size ratio of the defect element in the candidate media content; and adding, in response to the size ratio being less than a threshold, the candidate media content to the training media content set.

In some embodiments, the defect element includes a watermark element.

In some embodiments, the training phase of the model includes: determining, in response to the candidate media content comprising the defect element, a mask corresponding to the defect element, the mask indicating a region corresponding to the defect element; and determining a training loss corresponding to the candidate media content based on the mask, such that the training loss is independent of the region corresponding to the defect element.

In some embodiments, the training phase of the model includes: obtaining training media content and training text content corresponding to the training media content; determining position information of a set of text feature units corresponding to the training text content; updating a set of visual feature units corresponding to the training media content based on the position information; and training the model based on the updated set of visual feature units.

In some embodiments, updating the set of visual feature units corresponding to the training media content based on the position information includes: determining, from the set of text feature units, a target text feature unit corresponding to a target visual feature unit in the set of visual feature units; and adding a position encoding unit corresponding to the target text feature unit after the target visual feature unit based on the position information, the position encoding unit indicating a position of the target text feature unit in the set of text feature units.

In some embodiments, the model includes a plurality of processing layers, and the training process of the model includes: obtaining an intermediate feature representation output by an intermediate processing layer in the plurality of processing layers; encoding training media content by using a trained visual encoding model to determine a reference feature representation; and training the model based on a difference between the intermediate feature representation and the reference feature representation.

The units included in the apparatus 400 may be implemented in various ways, including software, hardware, firmware, or any combination thereof. In some embodiments, one or more units may be implemented using software and/or firmware, such as machine-executable instructions stored on a storage medium. In addition to machine-executable instructions or as an alternative, some or all units in the apparatus 400 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and more.

FIG. 5 illustrates a block diagram of an electronic device 500 in which one or more embodiments of the present disclosure may be implemented. It would be appreciated that the electronic device 500 shown in FIG. 5 is only illustrative, without suggesting any limitation to the function and scope of the embodiments described herein. The electronic device 500 shown in FIG. 5 may be used to implement the electronic device 110 shown in FIG. 1.

As shown in FIG. 5, the electronic device 500 is in the form of a general electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and may execute various processes based on the programs stored in the memory 520. In a multi-processor system, multiple processing units execute computer-executable instructions in parallel to improve the parallel processing capability of the electronic device 500.

The electronic device 500 typically includes multiple computer storage medium. Such medium may be any available medium that is accessible to the electronic device 500, including, but not limited to, volatile and non-volatile medium, removable and non-removable medium. The memory 520 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine-readable medium such as a flash drive, a disk, or any other medium, which may be used to store data and/or data (such as training data for training) and may be accessed within the electronic device 500.

The electronic device 500 may further include additional removable/non-removable, volatile/non-volatile memory medium. Although not shown in FIG. 5, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 520 may include a computer program product 525, which has one or more program modules configured to perform various methods or acts of the various embodiments of the present disclosure.

The communication unit 540 enables communication with other electronic devices through the communication medium. Additionally, the functions of the components of the electronic device 500 may be implemented by a single computing cluster or multiple computing machines, which may communicate through communication connections. Therefore, the electronic device 500 may use a logical connection with one or more other servers, a network personal computer (PC) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) through the communication unit 540 as needed, the external devices such as a storage device, a display device, etc., communicate with one or more devices that enable the user to interact with the electronic device 500, or communicate with any devices (such as a network card, a modem, etc.) that enable the electronic device 500 to communicate with one or more other electronic devices. Such communication may be performed via input/output (I/O) interfaces (not shown).

According to an illustrative implementation of the present disclosure, there is provided a computer-readable storage medium having computer-executable instructions stored thereon, where the computer-executable instructions are executed by a processor to implement the method described above. According to an illustrative implementation of the present disclosure, there is further provided a computer program product tangibly stored on a non-transitory computer-readable medium and including computer-executable instructions, and the computer-executable instructions are executed by a processor to implement the method described above.

Various aspects of the present disclosure are described herein with reference to the flowcharts and/or block diagrams of the method, the apparatus, the device, and the computer program product implemented according to the present disclosure. It would be appreciated that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable apparatus for generating media content, such that a machine is produced, so that when these instructions are executed by the processing unit of the computer or other programmable apparatus for generating media content, an apparatus for implementing functions/actions specified in one or more blocks of the flowcharts and/or block diagrams is generated. These computer-readable program instructions may also be stored in a computer-readable storage medium, these instructions enable the computer, the programmable apparatus for generating media content and/or other devices to work in a specific way, and thus the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, other programmable apparatus for generating media content, or other devices, such that a series of operations and steps are performed on the computer, the other programmable apparatus for generating media content, or the other devices, to generate a computer-implemented process, so that the instructions executed on the computer, the other programmable apparatus for generating media content, or the other devices implement the functions/actions specified in one or more blocks of the flowcharts and/or block diagrams.

The flowcharts and block diagrams in the drawings show the possibly implemented architectures, functions and operations of the system, the method and the computer program product according to multiple implementations of the present disclosure. In this regard, each block in the flowchart or block diagram may represent a module, program segment or part of instructions, and the module, program segment or part of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts, may be implemented by a dedicated hardware-based system that perform specified functions or actions, or may be implemented by a combination of dedicated hardware and computer instructions.

The implementations of the present disclosure have been described above, and the above description is illustrative, non-exhaustive, and not limited to the disclosed implementations. Without departing from the scope and spirit of the described implementations, many modifications and changes will be apparent to those of ordinary skill in the art. The choice of terms used herein is intended to best explain the principles of the implementations, the practical applications or improvements to the technology in the market, or to enable other ordinary skilled in the art to understand the implementations disclosed herein.

1. A method for generating media content, comprising:
obtaining input information; and
providing the input information to a model to generate the media content, wherein a training phase of the model comprises a first training phase and a second training phase,
the first training phase is configured to train the model by using a first set of training media content corresponding to a first resolution; and the second training phase is configured to sample a second resolution from a set of candidate resolutions; and train the model by using a second set of training media content corresponding to the second resolution, wherein a resolution range corresponding to the set of candidate resolutions is higher than the first resolution.

2. The method of claim 1, wherein the training phase of the model comprises:
determining a control feature based on a resolution of training media content; and
inputting the control feature to the model to train the model by using the training media content.

3. The method of claim 1, wherein the model comprises a diffusion model, and the training phase comprises:
sampling a first set of denoising time steps;
adjusting the first set of denoising time steps based on a resolution of training media content to determine a second set of denoising time steps; and
training the diffusion model by using the training media content based on the second set of denoising time steps.

4. The method of claim 1, wherein the model is trained by using a training media content set, and the training media content set is determined based on a process comprising:
obtaining candidate media content;
detecting whether the candidate media content comprises a defect element;
determining, in response to the candidate media content comprising the defect element, a size ratio of the defect element in the candidate media content; and
adding, in response to the size ratio being less than a threshold, the candidate media content to the training media content set.

5. The method of claim 4, wherein the defect element comprises a watermark element.

6. The method of claim 4, wherein the training phase of the model comprises:
determining, in response to the candidate media content comprising the defect element, a mask corresponding to the defect element, the mask indicating a region corresponding to the defect element; and
determining a training loss corresponding to the candidate media content based on the mask, such that the training loss is independent of the region corresponding to the defect element.

7. The method of claim 1, wherein the training phase of the model comprises:
obtaining training media content and training text content corresponding to the training media content;
determining position information of a set of text feature units corresponding to the training text content;
updating a set of visual feature units corresponding to the training media content based on the position information; and
training the model based on the updated set of visual feature units.

8. The method of claim 7, wherein updating the set of visual feature units corresponding to the training media content based on the position information comprises:
determining, from the set of text feature units, a target text feature unit corresponding to a target visual feature unit in the set of visual feature units; and
adding a position encoding unit corresponding to the target text feature unit after the target visual feature unit based on the position information, the position encoding unit indicating a position of the target text feature unit in the set of text feature units.

9. The method of claim 1, wherein the model comprises a plurality of processing layers, and the training process of the model comprises:
obtaining an intermediate feature representation output by an intermediate processing layer in the plurality of processing layers;
encoding training media content by using a trained visual encoding model to determine a reference feature representation; and
training the model based on a difference between the intermediate feature representation and the reference feature representation.

10. An electronic device, comprising:
at least one processing unit; and
at least one memory coupled to the at least one processing unit and storing instructions for execution by the at least one processing unit, the instructions, when executed by the at least one processing unit, causing the electronic device to perform operations comprising:
obtaining input information; and
providing the input information to a model to generate the media content, wherein a training phase of the model comprises a first training phase and a second training phase,
the first training phase is configured to train the model by using a first set of training media content corresponding to a first resolution; and the second training phase is configured to sample a second resolution from a set of candidate resolutions; and train the model by using a second set of training media content corresponding to the second resolution, wherein a resolution range corresponding to the set of candidate resolutions is higher than the first resolution.

11. The electronic device of claim 10, wherein the training phase of the model comprises:
determining a control feature based on a resolution of training media content; and
inputting the control feature to the model to train the model by using the training media content.

12. The electronic device of claim 10, wherein the model comprises a diffusion model, and the training phase comprises:
sampling a first set of denoising time steps;
adjusting the first set of denoising time steps based on a resolution of training media content to determine a second set of denoising time steps; and
training the diffusion model by using the training media content based on the second set of denoising time steps.

13. The electronic device of claim 10, wherein the model is trained by using a training media content set, and the training media content set is determined based on a process comprising:
obtaining candidate media content;
detecting whether the candidate media content comprises a defect element;
determining, in response to the candidate media content comprising the defect element, a size ratio of the defect element in the candidate media content; and
adding, in response to the size ratio being less than a threshold, the candidate media content to the training media content set.

14. The electronic device of claim 13, wherein the defect element comprises a watermark element.

15. The electronic device of claim 13, wherein the training phase of the model comprises:
determining, in response to the candidate media content comprising the defect element, a mask corresponding to the defect element, the mask indicating a region corresponding to the defect element; and
determining a training loss corresponding to the candidate media content based on the mask, such that the training loss is independent of the region corresponding to the defect element.

16. The electronic device of claim 10, wherein the training phase of the model comprises:
obtaining training media content and training text content corresponding to the training media content;
determining position information of a set of text feature units corresponding to the training text content;
updating a set of visual feature units corresponding to the training media content based on the position information; and
training the model based on the updated set of visual feature units.

17. The electronic device of claim 16, wherein updating the set of visual feature units corresponding to the training media content based on the position information comprises:
determining, from the set of text feature units, a target text feature unit corresponding to a target visual feature unit in the set of visual feature units; and
adding a position encoding unit corresponding to the target text feature unit after the target visual feature unit based on the position information, the position encoding unit indicating a position of the target text feature unit in the set of text feature units.

18. The electronic device of claim 10, wherein the model comprises a plurality of processing layers, and the training process of the model comprises:
obtaining an intermediate feature representation output by an intermediate processing layer in the plurality of processing layers;
encoding training media content by using a trained visual encoding model to determine a reference feature representation; and
training the model based on a difference between the intermediate feature representation and the reference feature representation.

19. A non-transitory computer-readable storage medium having a computer program stored thereon, the computer program, when executed by a processor, implementing operations comprising:
obtaining input information; and
providing the input information to a model to generate the media content, wherein a training phase of the model comprises a first training phase and a second training phase,
the first training phase is configured to train the model by using a first set of training media content corresponding to a first resolution; and the second training phase is configured to sample a second resolution from a set of candidate resolutions; and train the model by using a second set of training media content corresponding to the second resolution, wherein a resolution range corresponding to the set of candidate resolutions is higher than the first resolution.

20. The non-transitory computer-readable storage medium of claim 19, wherein the training phase of the model comprises:
determining a control feature based on a resolution of training media content; and
inputting the control feature to the model to train the model by using the training media content.
